(19) United States
(12) Patent Application Publication
(10) Pub. No.: US 2002/0159168 A1
(43) Pub. Date: Oct. 31, 2002

(54) Multiple mode rear view mirrors

(76) Inventors: Jeanette Epps, Southfield, MI (US); Vijitha Senaka Kiridena, Ann Arbor, MI (US)

Correspondence Address: DYKEMA GOSSETT PLLC, 39577 WOODWARD AVENUE, SUITE 300, BLOOMFIELD HILLS, MI, 48304, US

(21) Appl. No.: 09/681,540

(22) Filed: Apr. 25, 2001

(51) Int. Cl. G02B 5/08

(52) U.S. Cl. 359/868; 359/838; 359/871; 359/879

(57) ABSTRACT

An automotive rear view mirror assembly 7 is provided. The mirror assembly 7 has a flexible mirror surface 10. The mirror surface 10 has a first state of curvature about a first axis 14. In the first state of curvature, the mirror surface 10 is flat. The mirror surface 10 has a second state of curvature that is typically convex. To move the mirror surface between the first and second states of curvature, there is provided an actuator 18. The actuator may be mechanically, hydraulically, pneumatically or electrically actuated.

### BACKGROUND OF INVENTION

The field of the present invention is that of rear view mirrors for vehicles. More particularly, the field of the present invention is a multiple curvature mode, rear view mirror and methods of utilization thereof.

Automotive vehicles are equipped with rear view mirrors. Most vehicles have three rear view mirrors. One rear view mirror is typically placed within the passenger compartment of the vehicle. A second rear view mirror is usually placed on the exterior of the vehicle body connected adjacent to an A pillar on a rear portion of the front fender or on a front portion of the vehicle door on the driver's side. A third rear view mirror is placed similar to the second rear view mirror, only on the passenger side of the vehicle. There are two major types of mirrors, planar and convex. Planar mirrors give a true, not-to-scale image and accordingly allow a driver to accurately judge the distance of objects viewed in the mirror. However, due to adjustment of the mirrors, the location of the mirrors, the height and seating position of the vehicle driver, and the B pillar and C pillar of the vehicle, there may be certain areas in a spatial envelope behind and laterally adjacent to the vehicle that cannot be viewed by the use of planar mirrors alone. Accordingly, many vehicles have a convex mirror on the passenger side of the vehicle. A convex mirror provides a view of a wider range to the vehicle than does a planar mirror. However, a convex mirror is a disadvantage in that the objects seen in such a mirror are typically closer to the vehicle than they appear to be to the driver of the vehicle. In large vehicles, the exterior rear view mirror is of such a size that a convex mirror patch can be applied to the larger planar mirror providing the driver with both modes of rear view mirrors. However, in most vehicles, this solution is impractical due to the overall size of the exterior rear view mirror and also due to the fact that the rear view mirror for an automobile is vertically much lower in position than a rear view mirror on large vehicles.

It is desirable to provide a rear view mirror for a vehicle that can be viewed in both a planar and convex mode based upon the desire of the vehicle operator.

### SUMMARY OF INVENTION

To make manifest the above noted and other manifold desires, a revelation of the present invention is brought forth. In a preferred embodiment, the mirror surface of the present invention has a flexible polymeric substrate layer. The flexible polymeric substrate layer has a silicon carbide reflective layer deposited thereon. Contacting the polymeric substrate layer generally opposite the reflective layer and being intimately connected therewith is an actuator layer. Preferably, the actuator will be a high displacement piezoelectric actuator. When a voltage is applied to the actuator, the flexible mirror surface is moved from a planar surface to a convex, curved surface. Accordingly, the mirror assembly moves from a planar mode of operation to a convex mode of operation. Additionally, a light indicator can be used to alert a driver to the mode of operation of the mirror assembly. In still more advanced embodiments, the conversion between the modes of operation of the mirror can be made automatic by a proximity sensor that senses an object or other vehicle in close proximity to the vehicle.

It is an advantage of the present invention to provide a mirror assembly for a vehicle that has at least two differing states of curvature. It is an advantage of the present invention to provide a mirror assembly that can provide both a planar reflective surface and a convex reflective surface. It is still another advantage of the present invention to provide a mirror assembly that can automatically switch from a planar mirror surface to a convex mirror surface.

The above-noted and other advantages of the present invention will become more apparent to those skilled in art from a review of the invention as it is brought forth in the accompanying drawings and detailed description.

### BRIEF DESCRIPTION OF DRAWINGS

FIG. 1 is a top plan view of a vehicle illustrating the ranges of sight of a rear view mirror in a planar mode and convex mode.

FIG. 2 is a schematic view of the mirror assembly, illustrating the various layers of material of the present invention.

FIGS. 3(a) and 3(b) illustrate the reaction of the flexible mirror surface of FIG. 2 when exposed to a voltage source.

FIG. 4 is a schematic view of a linear stroke actuator for managing a state of curvature for a mirror surface and mirror assembly according to the present invention.

FIG. 5 is a schematic view of an indicator to allow a vehicle operator to be cognizant of the state of curvature of a mirror assembly according to the present invention.

FIG. 6 is a schematic view of a mirror assembly according to the present invention that utilizes a pneumatic actuator.

### DETAILED DESCRIPTION

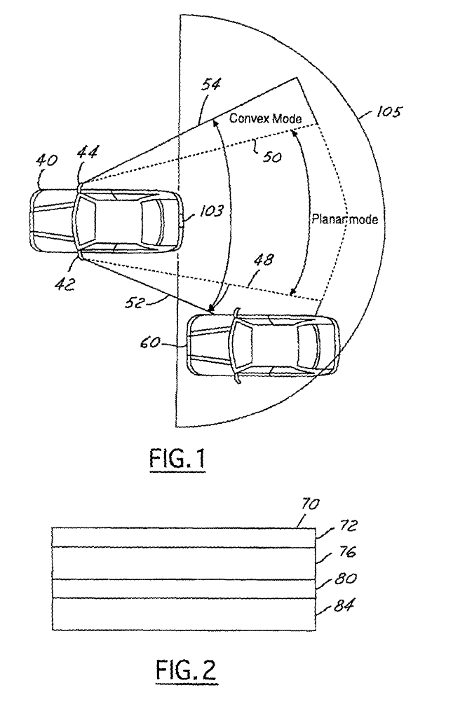

Referring to FIGS. 1-4, the automotive rear view mirror assembly 7 according to the present invention has a mirror surface 10. The spherical mirror surface 10 is flexible. The mirror surface has a first state of curvature about a first axis 14. In the first state of curvature, the mirror surface 10 is flat. The mirror surface 10 has a second state of curvature that differs from the first state of curvature. The second state of curvature of the mirror surface 10 is illustrated along the dotted line 16. In the second state of curvature, the mirror surface 10 is generally convex with respect to axis 14. To move the mirror surface 10 between the first and second states of curvature, there is provided a linear stroke actuator 18. The linear actuator 18 may be mechanically, hydraulically, pneumatically or electrically actuated to extend or retract a plunger 22. The plunger 22 is connected with a semi-elliptical or parabolic head 24, which makes engaging contact with the back 28 of the mirror surface. The mirror surface 10 typically will have a default state of a planar surface. Preferably the mirror surface will be spherical in its second state of curvature.

FIG. 1 illustrates a line of sight for a driver in a vehicle 40. When the rear view mirrors 42, 44 are in the planar mode, a typical driver of vehicle 40 will have a line of vision bordered by lines 48, 50. If the rear view mirrors 42, 44 are in a convex mode of operation, lines 52, 54 border the line of sight. In the planar mode of operation, vehicle 60, which is slightly rearward and laterally adjacent vehicle 40, is outside the line of sight of vehicle 40's driver. However, if mirror 42 is in a convex mode, vehicle 60 will be within the line of sight of vehicle 40's driver.

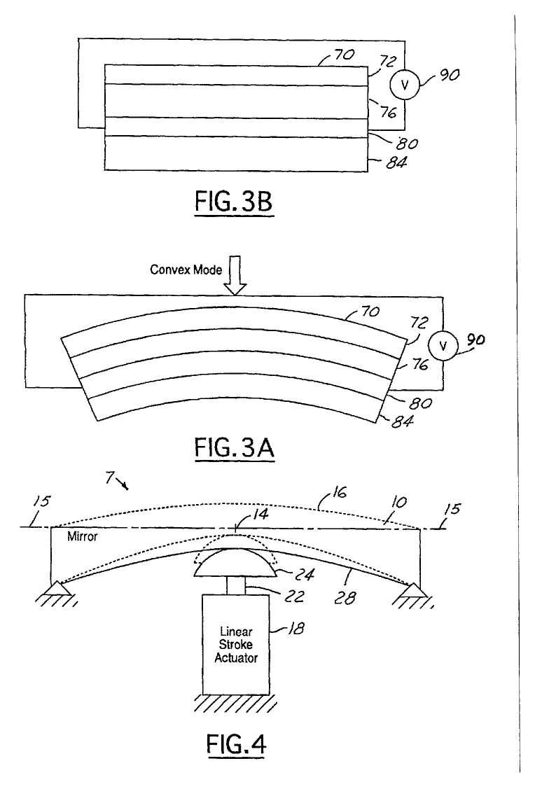

Referring in particular to FIGS. 2, 3A and 3B, in an alternate preferred embodiment of the present invention, the flexible mirror surface 70 is provided by a composite layer member. The mirror surface 70 includes a reflective layer 72 of silicon carbide. The silicon carbide layer 72 is deposited on a polymeric substrate layer 76. The polymeric substrate layer 76 can typically be a carbon fiber reinforced polymer. The silicon reflective layer 72 can be applied to the polymeric substrate layer 76 by a plasma spray process.

In the plasma spray process an inert gas mixture is heated to the point of becoming plasma and is then accelerated by an electric charge. The high velocity heated plasma is used to melt the silicon carbide and then propel it to the substrate.

In an alternate process, the silicon carbide reflective layer 72 is applied utilizing chemical vapor deposition. Chemical vapor deposition involves gases at a high temperature and control pressure within a special chamber. The gases within the chamber undergo a chemical reaction that results in growing a thin layer of silicon carbide on the polymeric substrate layer 76.

Contacting the polymeric substrate layer 76 and being intimately connected therewith is a piezoelectric actuator layer 80. As shown in FIG. 3B, the actuator utilized is a Thunder™ high displacement piezoceramic actuator, which was developed by the National Aeronautic and Space Administration (NASA). A piezoceramic actuator with dimensions of 95×70×0.56 mm can produce approximately 30 pounds of block force and 7.5 mm of displacement. The thickness of 0.56 mm includes a piezoelectric actuator with a thickness of 0.25 mm with insulation surrounding it.

Opposite the layer 76 is a structural layer 84. The structural layer 84 will typically be another polymeric layer which is similar or identical to layer 76. The layers 76, 84 give structural integrity to the mirror surface and protect the actuator layer 80 and electrically insulate the same.

Referring to FIGS. 3A and 3B in its non-actuated state, the mirror surface 70 is planar. When placed in the mirror assembly a voltage source 90 is connected with opposite ends of the actuator layer 80. As best shown in FIG. 3A, when voltage is applied to the actuator layer 80, the mirror surface 70 moves to a second state of curvature to provide a convex mirror surface. The voltage power supply can be located in a special compartment away from the rear view mirror, that is convenient from a space and wiring standpoint of the vehicle.

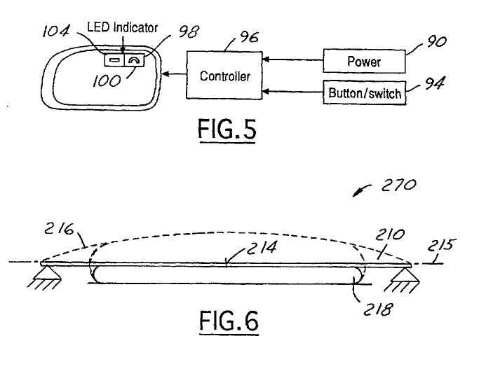

Turning to FIG. 5, the voltage source 90 is controlled by an operator powered switch 94. The switch is connected with a controller 96. The controller 96 powers an LED indicator 98. The LED indicator 98 has two indicator lights 100, 104. The indicator light 104 indicates a flat mode of operation. The indicator light 100 indicates a convex mode of operation. Accordingly the vehicle operator need not guess which mode of operation the mirror assembly is in but can receive visual confirmation of the mode of operation by looking at the indicator 98.

Referring to FIG. 6, a third embodiment rear view mirror assembly 270 according to the present invention is provided with a polymeric coated mirror surface 210. A bladder 218 provides a pneumatic actuator. In its convex state of curvature shown along line 216, the mirror surface 210 has curvature with respect to an axis 214 and with respect to a perpendicular axis 215. The bladder 218 may be customized in order to provide the optimum two-axis (spherical) curvature of the mirror surface 210 when the bladder 218 is inflated.

Referring back to FIG. 1, the vehicle 40 may have a proximity sensor 103. The sensor 103 may be a sonic sensor or ultrasonic sensor. In still other instances the sensor 103 can be a radar sensor or a sensor that can work by other electromagnetic phenomena. The sensor 103 senses the proximity of other vehicles such as vehicle 60 or other objects within a spatial envelope typically rearward and laterally adjacent to the vehicle 40, which, for purposes of illustration, is shown as perimeter line 105. When the sensor 103 detects the proximity of the vehicle 60, the mirror assembly 7 is changed to the convex mode. When the vehicle 60 accelerates past the vehicle 40 and no object or vehicle is detected, the mirror assembly 7 may be programmed to revert to the planar mode.

While preferred embodiments of the invention have been disclosed, it is to be understood that they have been disclosed by way of example only and that various modifications can be made without departing from the spirit and scope of the invention as it is encompassed by the following claims.

1. An automotive rear view mirror comprising:
a flexible mirror surface having at least a first state of curvature and a second state of curvature differing from said first state of curvature; and
an actuator to move said mirror surface between said first and second states of curvature.

2. An automotive rear view mirror as described in claim 1, wherein said first state of curvature of said mirror surface is generally flat and said second state of curvature of said mirror surface is generally curved.

3. An automotive rear view mirror as described in claim 2, wherein said second state of curvature of said mirror surface is convex.

4. An automotive rear view mirror as described in claim 3 wherein said second state of curvature of said mirror surface is spherical.

5. An automotive rear view mirror as described in claim 1, wherein said actuator is a linear stroke actuator.

6. An automotive rear view mirror as described in claim 1, wherein said actuator is fluidly powered.

7. An automotive rear view mirror as described in claim 1, wherein said actuator is piezoelectric.

8. An automotive rear view mirror as described in claim 6, wherein said actuator is piezoceramic.

9. An automotive rear view mirror as described in claim 1, wherein said mirror surface is a flexible substrate coated with a reflective coating.

10. An automotive rear view mirror as described in claim 9, wherein said reflective coating is applied to said substrate by a plasma spray process.

11. An automotive rear view mirror as described in claim 9, wherein said reflective coating is applied to said substrate by chemical vapor deposition.

12. An automotive rear view mirror as described in claim 9, wherein said reflective coating is silicon carbide.

13. An automotive rear view mirror as described in claim 9, wherein said flexible substrate is a polymeric material.

14. An automotive rear view mirror as described in claim 13, wherein said polymeric material is a carbon fiber reinforced polymer.

15. An automotive rear view mirror as described in claim 7, wherein in a state of no applied voltage, said mirror surface is generally flat.

16. An automotive rear view mirror as described in claim 13, having a substrate layer on both sides of a piezoelectric actuator layer.

17. An automotive rear view mirror as described in claim 1, further including an indicator to provide visual confirmation of the state of curvature of said mirror surface.

18. An automotive vehicle rear view mirror assembly comprising:
a flexible mirror surface provided by a polymeric substrate which is coated with a reflective material, said mirror surface having a first planar mode and a second convex mode;
a piezoelectric actuator connected with said substrate to move said mirror surface between said modes; and
a voltage source causing said actuator to move between said first and second modes.

19. A method of adjusting a rear view mirror for an automotive vehicle comprising:
providing a flexible mirror surface having at least a first state of curvature and a second state of curvature differing from said first state of curvature; and
moving said mirror surface between said first and second states of curvature.

20. A method of adjusting a rear view mirror as described in claim 19, wherein said method of adjusting said flexible mirror surface is by applying a voltage to piezoelectric material connected to said flexible mirror surface.

21. A method of adjusting a rear view mirror as described in claim 19, further including a visual indicator of said states of curvature of said mirror surface.

22. A method of adjusting a rear view mirror as described in claim 19, wherein said first state of curvature of said mirror surface has a generally flat planar surface, and said second state of curvature of said mirror surface has a convex curvature; and
said method including steps to sense the proximity of another object about said vehicle and automatically adjusting said flexible mirror surface from said first planar state of curvature to said second convex state of curvature.

23. A method of adjusting a rear view mirror as described in claim 22 wherein said proximity of said object is sensed by a light sensor.

24. A method of adjusting a rear view mirror as described in claim 22 wherein said proximity of said object is sensed by a sonic sensor.

25. A method of adjusting a rear view mirror as described in claim 22 wherein said proximity of said object is sensed by a radar sensor.
